(19) United States
(12) Patent Application Publication
(10) Pub. No.: US 2024/0155335 A1
(43) Pub. Date: May 9, 2024

(54) METHODS AND APPARATUSES FOR PRIVACY ENHANCEMENT THROUGH MAC ADDRESS MASQUERADING

(71) Applicant: INTERDIGITAL PATENT HOLDINGS, INC., Wilmington, DE (US)

(72) Inventors: Antonio de la Oliva, Madrid (ES); Joseph Levy, Merrick, NY (US); Robert Gazda, Spring City, PA (US)

(73) Assignee: INTERDIGITAL PATENT HOLDINGS, INC., Wilmington, DE (US)

(21) Appl. No.: 18/279,554

(22) PCT Filed: Mar. 4, 2022
(86) PCT No.: PCT/US2022/018928

§ 371 Date: Aug. 30, 2023

Related U.S. Application Data
(60) Provisional application No. 63/157,300, filed on Mar. 5, 2021.

(51) Int. Cl. H04W 12/02; H04W 12/033; H04W 12/08

(52) U.S. Cl. CPC H04W 12/02; H04W 12/033; H04W 12/08

(57) ABSTRACT

Methods and apparatuses for privacy enhancement are provided herein. A method performed by a station, STA (201), may include transmitting, to an access point, AP (202), a first frame including information indicating that the STA (201) will use an over-the-air medium access control, otaMAC, address for a frame sent to the AP (202). The method may further include generating (210) a second frame for transmission to the AP (202) including a network MAC, nMAC, address of the STA (201), encrypting (211) the generated second frame, and replacing (212) the nMAC address with an otaMAC address either during the encryption or after the encryption. The method may further include transmitting (213) the encrypted second frame, including the otaMAC, to the AP (202), such that the AP (202) may replace (214) the otaMAC address with the nMAC address and decrypt (215) the second frame for forwarding via a distribution system, DS (203).

### BACKGROUND

The Institute of Electrical and Electronics Engineers (IEEE) standards for 802.11 have seen a trend in recent years towards providing new mechanisms for the protection of the privacy of individuals using wireless local area network (WLAN) technology. One of the main areas of work in this aspect involves protecting users from those who track them. This means protecting the possible identification of users as they roam to and from different locations and IEEE 802.11 networks.

Several modifications to the baseline specification are being introduced in IEEE 802.11aq. These modifications may support current medium access control (MAC) Privacy features. These features may focus on protecting the privacy of the user in a non-associated state. In embodiments described herein, MAC Privacy enhancements are provided for the baseline specification (IEEE 802.11-2020) and new work starting in the IEEE 802.11bi and IEEE 802.11bh specifications.

### SUMMARY

Methods and apparatuses for privacy enhancement are provided herein. A method performed by a station (STA) may include transmitting, to an access point (AP), a first frame including information indicating that the STA will use an over-the-air medium access control (otaMAC) address for a frame sent to the AP. The method may further include generating a second frame for transmission to the AP including a network MAC (nMAC) address of the STA, encrypting the generated second frame, and replacing the nMAC address with an otaMAC address either during the encryption or after the encryption. The method may further include transmitting the encrypted second frame, including the otaMAC, to the AP, such that the AP may replace the otaMAC address with the nMAC address and decrypt the second frame for forwarding via a distribution system (DS).

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 10 is a system diagram illustrating an example radio access network (RAN) and an example core network (CN) that may be used within the communications system illustrated in FIG. 1A according to an embodiment;

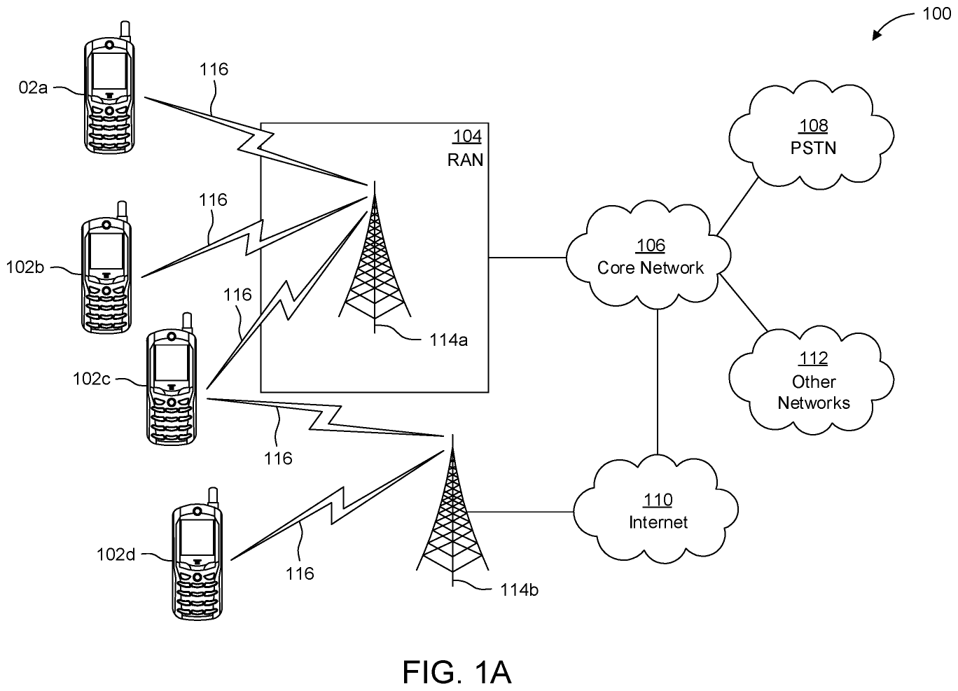

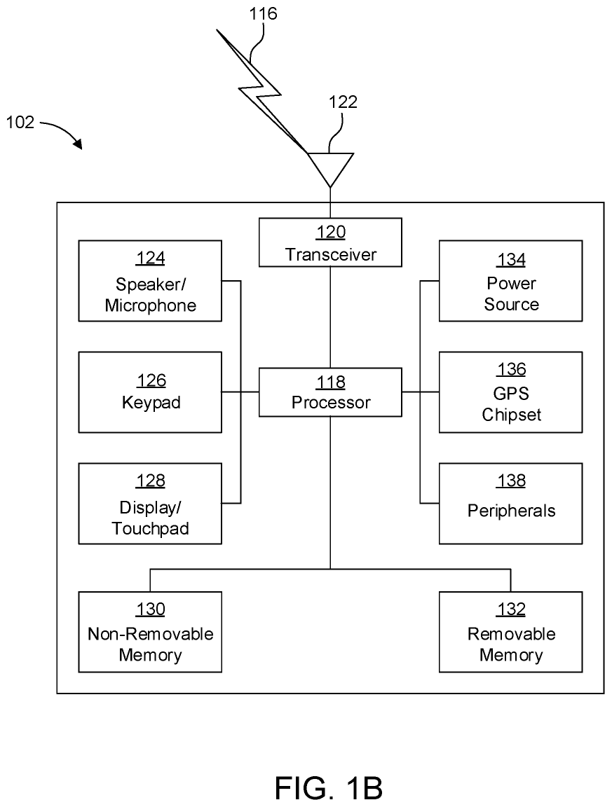

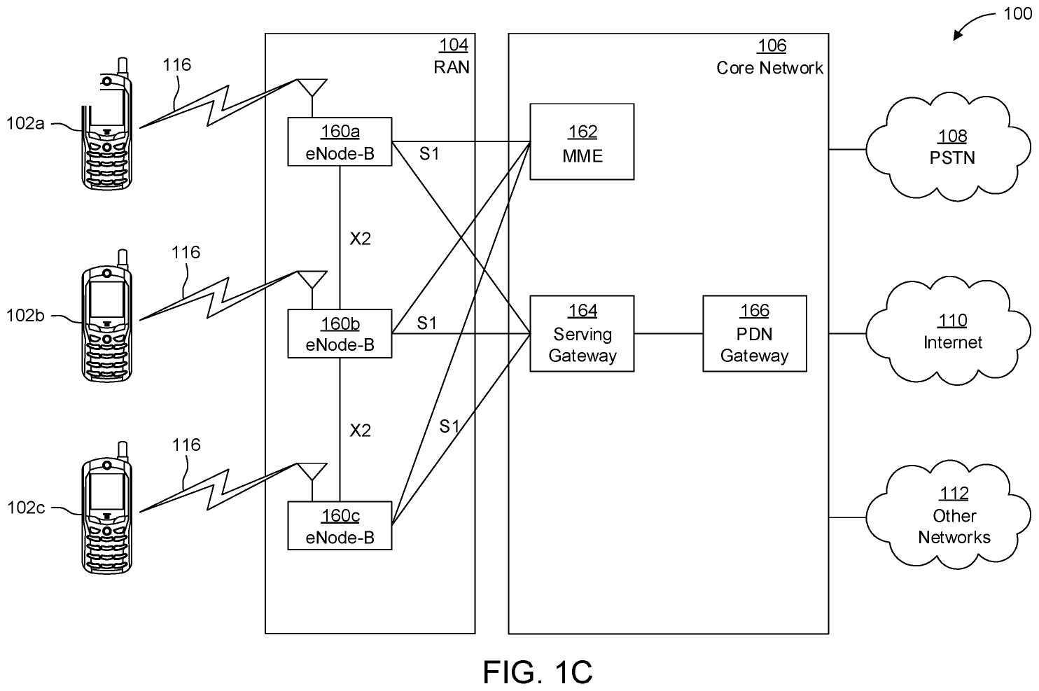

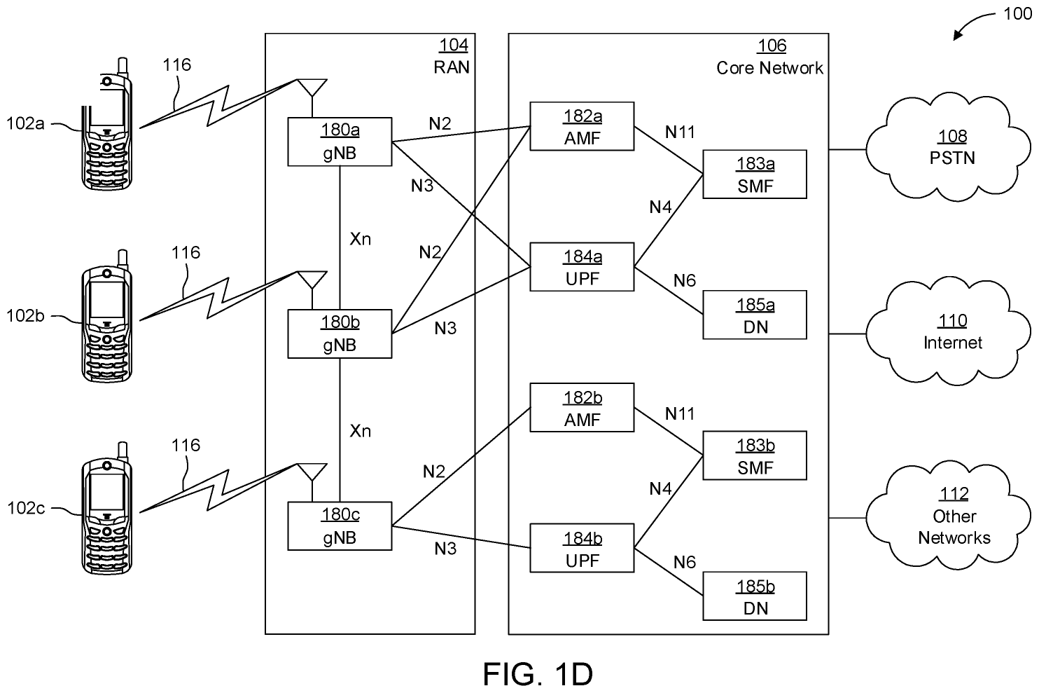

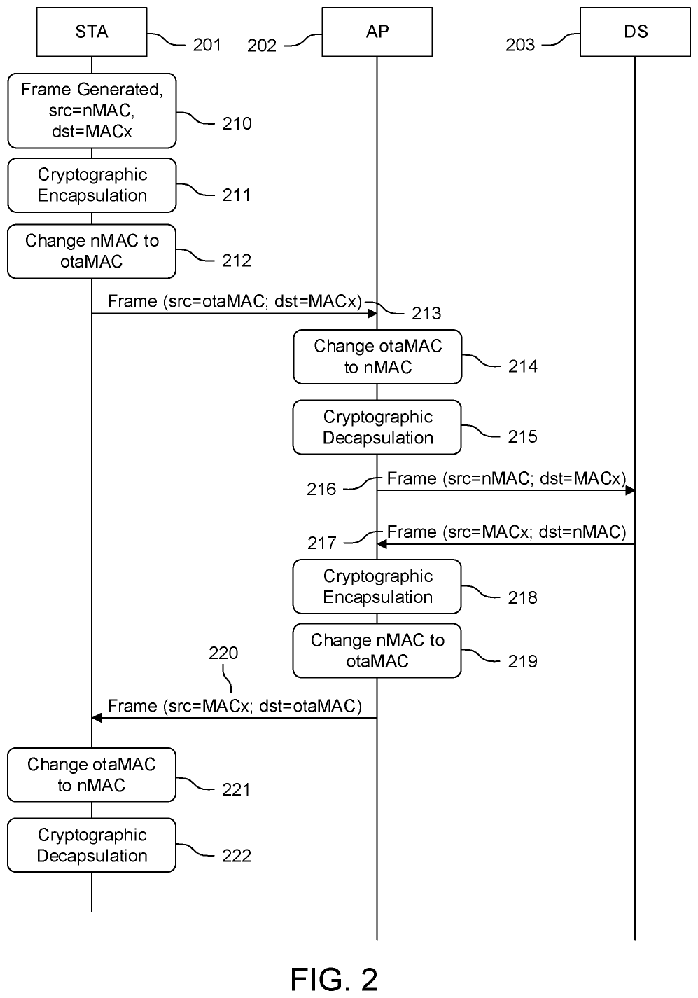

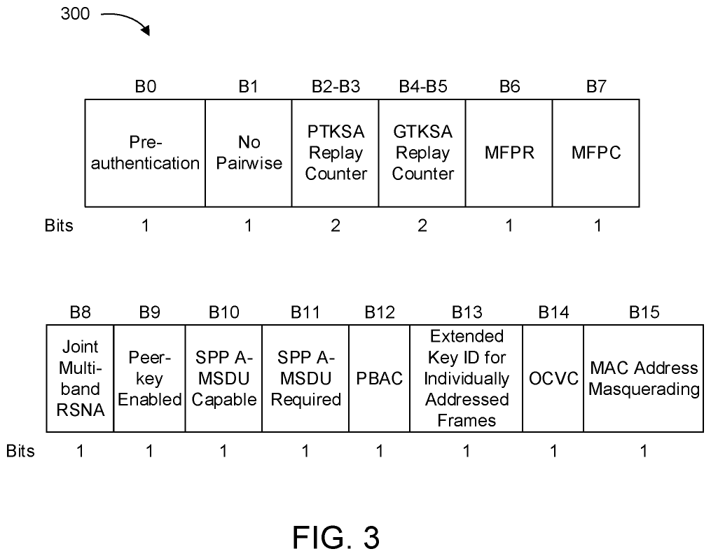

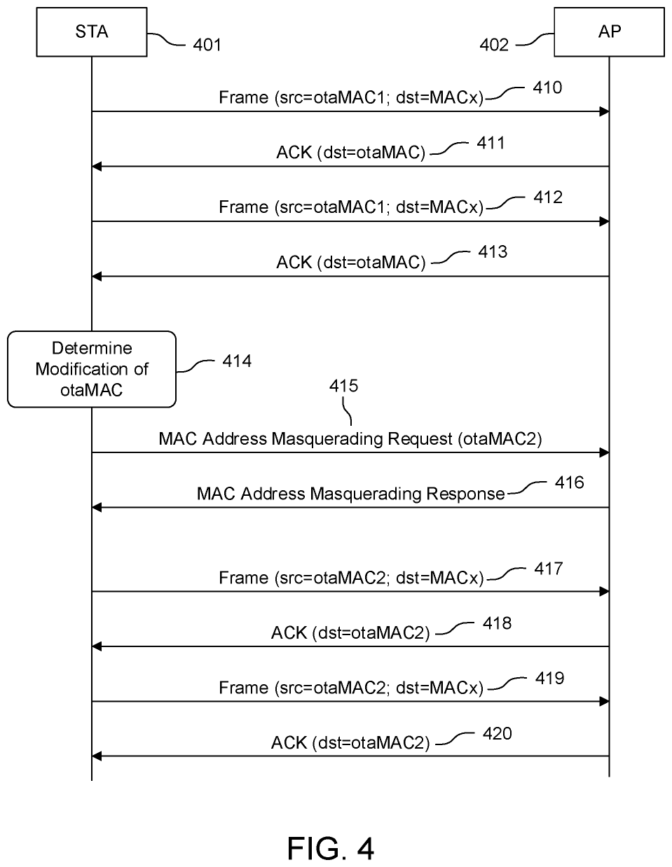

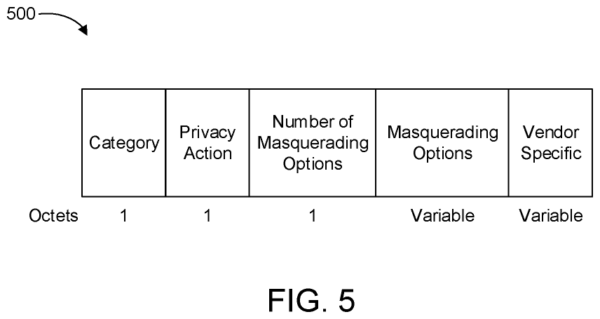

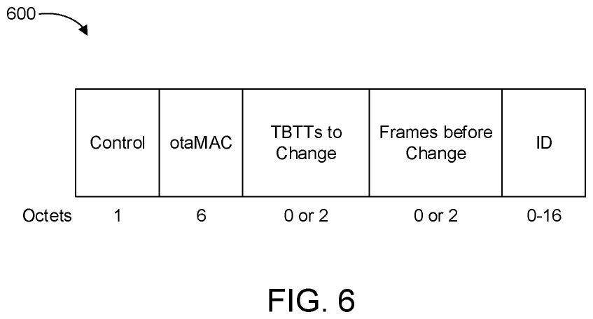

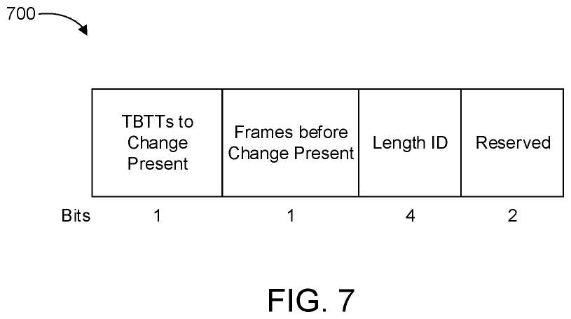

FIG. 1D is a system diagram illustrating a further example RAN and a further example CN that may be used within the communications system illustrated in FIG. 1A according to an embodiment;

FIG. 2 presents an overview of the operation of one example system including a station (STA), an access point (AP), and a distribution system (DS);

FIG. 3 illustrates an example of an extension to a robust security network (RSN) capabilities field;

FIG. 4 illustrates an example scenario showing an overall exchange and operation of control/management frames;

FIG. 5 shows an example of a format of a medium access control (MAC) Address Masquerading Request frame;

FIG. 6 portrays an example of a Masquerading Options field as may be included in a MAC Address Masquerading Request Frame;

FIG. 7 portrays an example of a Control subfield as may be included in a Masquerading Options field of the MAC address Masquerading Request frame;

FIG. 8 illustrates an example of a format of a MAC Address Masquerading Response frame;

FIG. 9 illustrates an example of a definition of a MAC Address Masquerading Switch Announcement frame;

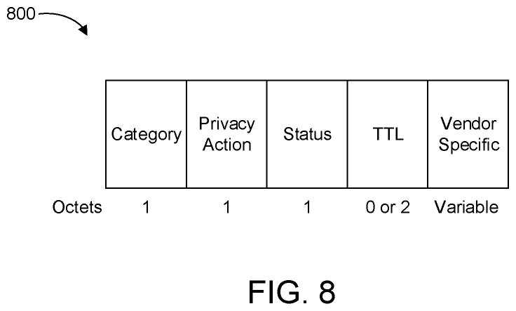

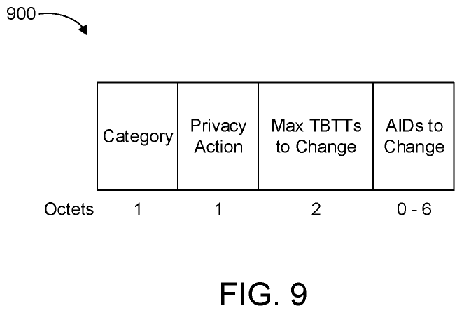

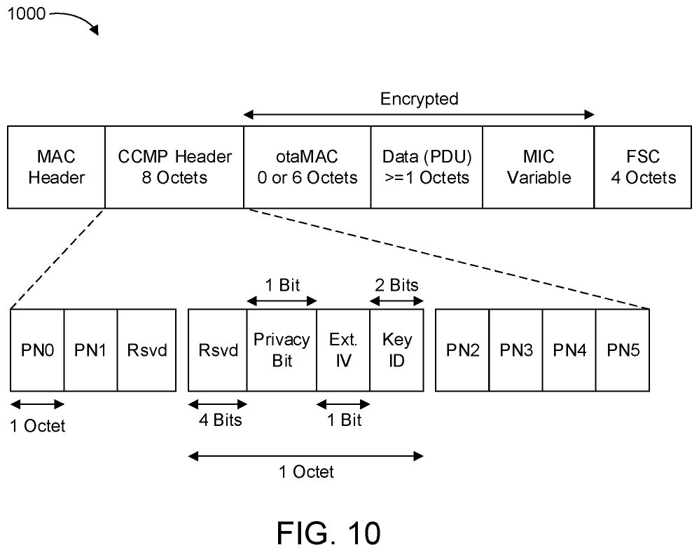

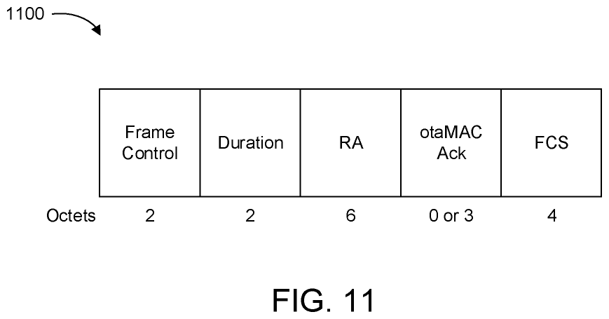

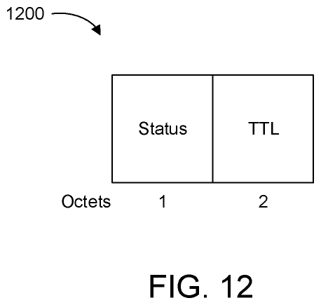

FIG. 10 portrays an example of counter mode cipher block chaining message authentication code protocol (CCMP) header extension and piggybacking of over-the-air MAC (otaMAC) information;

FIG. 11 illustrates an example of an extension to the ACK format; and

FIG. 12 illustrates an example of an otaMAC Ack field.

### DETAILED DESCRIPTION

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a g NB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 10 is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 10, the eNode-Bs 160a, 160b, 160c may communicate with one another over an X2 interface.

The CN 106 shown in FIG. 10 may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

MAC Privacy enhancements are described herein. Several features in IEEE 802.11 can be used to track users. Prior to being associated with an AP, a STA may define the MAC address that it is going to use for the duration of the association. Before MAC privacy enhancements were added to the base line specification, the STA would use its hard-wired MAC address for all associations. This behavior made the tracking of the STA trivial since observing the MAC address in pre-association messages allowed the tracking of the STA.

In addition to the MAC address, there are other mechanisms that may be used to track a STA in IEEE 802.11. For example, each frame in the communication may have a sequence number associated with it. Even after a MAC address is changed, this sequence number may be used to track the STA, since consecutive frames may show consecutive sequence numbers. Some other mechanisms are more complex, such as the OFDM PHY DATA scrambler, which may also be tracked if not reseeded.

MAC privacy enhancements may enable the STA to modify all these parameters in a pre-association state, in such a way that a user may not be trivially tracked while it roams before becoming associated with an AP or while the STA changes network access. The MAC privacy enhancements may mitigate this sort of traffic analysis. A STA may support the ability to periodically and randomly change its MAC addresses and reset counters and seeds prior to association. While discovering networks, a STA may refrain from gratuitously transmitting Probe Request frames containing service set identifiers (SSIDs) of favored basic service set (BSS) networks.

Requirements for support of MAC privacy enhancements are described herein. The baseline IEEE 802.11 specification may define a set of requirements for applying MAC address randomization. For example, the STA may periodically change its MAC address to a random value while not associated to a BSS. The STA may construct the randomized MAC address from the locally administered address space, which may be defined in standard specifications such as IEEE Std 802-2014 or IEEE Std 802c-2017. The non-AP STA may not be permitted, or may otherwise be unable to, change its MAC address during a transactional exchange. An examples of such an exchange may be during the transmission or reception of Public Action frames for pre-association discovery. Another instance in which the non-AP STA may not change its MAC address may be during the establishment of a state with an AP using pre-association capabilities, such as robust security network (RSN) pre-authentication or fast transition (FT) over-the-DS (distributed system). If a non-AP STA starts any transaction that establishes a state bound to a MAC address and decides to establish an association or a transaction state with a discovered BSS, it may change the MAC address to the one used to establish this state. A state established with an AP using a prior MAC address, such as an RSN pre-authentication state or an FT state established over-the-DS, may be bound to the MAC address used when that state was created. In some cases, when a MAC address is changed to a new random value, counters in all sequence number spaces used to identify each frame may need to be reset. The non-AP STA connecting to an infrastructure BSS may retain a single MAC address for the duration of its connection across an extended service set (ESS).

Although MAC privacy enhancements may highly improve the privacy of the user, they may not be enough. Due to the insufficiency of existing enhancements, the IEEE 802.11 created the RCM group to further study privacy enhancements and how to improve the operation of networks in which MAC address randomization is used. The RCM study group concluded operation in 2020 and two PARs have been proposed: IEEE 802.11bi, which provides for enhanced service with data privacy protection, and IEEE 802.11bh, which describes operation with randomized and changing MAC addresses. IEEE 802.11bi specifies modifications to the IEEE Std 802.11 MAC to include new mechanisms that address and improve user privacy. IEEE 802.11bh specifies modifications to the MAC mechanisms to preserve the existing services that might otherwise be restricted in environments where STAs in an ESS use randomized or changing MAC addresses, without affecting user privacy. IEEE 802.11bh may involve work on mechanisms to enable session continuity in the absence of any unique MAC address-to-STA mapping.

Embodiments described herein may relate to the IEEE 802.11bi and IEEE 802.11bh work, and may provide mechanisms broadening the operation space of MAC Privacy enhancements. In existing 802.11 networks, STAs may utilize a fixed and unique MAC address for over-the-air transmissions with a STA's associated AP. This allows others to track the STA by observing its MAC address in over-the-air messages, similarly as may be observed in pre-association messages. The baseline IEEE 802.11 specification may not support the dynamic modification of a STA's MAC address in the associated state.

To enhance privacy, embodiments described herein may at least address: (1) the relationship between the MAC address used for over-the-air transmission and the MAC address used in the wired/secure part of the network for security association; and (2) enablement of periodic modification of STA MAC addresses within the context of STAs associated with an AP, while maintaining the STA's connectivity/identity.

Various embodiments proposed herein, which may entail changes to existing IEEE 802.11 procedures, may enable the periodic modification of MAC addresses within the context of a STA's association with an AP, while maintaining the STA's connectivity/identity. Such solutions may include: (1) a new privacy enhancement called MAC Address masquerading (which may provide for dynamic and/or periodic modification of a STA's MAC address while associated with an AP); (2) new mechanisms for the advertisement of the new MAC address masquerading privacy enhancements; (3) control/management frame exchange mechanisms for the signaling of the MAC address changes in an associated state, with a robust security network association (RSNA) established; and (4) mechanisms for the signaling of the MAC address change in an associated state, with a RSNA established, through piggybacking of information in data and acknowledgment (ACK) frames.

To achieve MAC Address masquerading, embodiments described herein may define at least two new types of MAC addresses, including their differences among network segments and their function. The two new types of MAC addresses may be referred to herein as the network MAC address (nMAC) and over-the-air MAC address (otaMAC).

An nMAC may correspond to the MAC address used for association and authentication processes between the AP and the STA, and the nMAC may be a MAC addresses that is indexed in the RSNA. This MAC address may be used to set up the RSNA for routing traffic to the STA on a wired network segment. is the nMAC may also be the one used for mobility-related operations such as Fast Transition mechanisms.

The otaMAC may be included in over-the-air frames between a STA and an AP. For example, the otaMAC may be included in address 2 or 3 of an IEEE 802.11 frame. One purpose of the otaMAC may be to maintain the privacy of the nMAC of the STA. The otaMAC may potentially be changed on a per-packet basis.

The use of these MAC addresses may require the AP and STA to keep a binding between the nMAC and the otaMAC. In addition, the AP and STA may need to modify the packets received to swap the otaMAC by the nMAC prior to decrypting the frame, as explained in embodiments further described below.

Various theories of operation for the proposed embodiments are described herein. As explained substantially in paragraphs above, an aim of the embodiments described herein may be to enable mechanisms by which a STA can modify its MAC address as is carried within the over-the-air frames. In addition, the solutions described herein may enable such modification without the burden of needing to rekey or regenerate the RSNA between STAs and APs.

FIG. 2 presents an overview of the operation of one example system including a STA 201, an AP 202, and a distribution system (DS) 203.

A STA (e.g., STA 201 in FIG. 2) may discover and advertise its ability to change its MAC address by using any of the mechanisms defined further herein. After the STA and the AP (e.g., AP 202 as shown in FIG. 2) have mutually identified their MAC address masquerading capabilities, the AP and STA may establish a connection, by following the procedures of authentication and association defined in IEEE 802.11. Such methods may be defined in IEEE 802.11-2020, and may include, for example, e.g., SAE, FILS, FT, 802.1X or Open Authentication.

Once the STA and AP are associated and an RSNA has been established, the AP and STA may have defined an nMAC for the communication. In such case, the nMAC may be defined as the MAC address used to generate the RSNA.

At any point in time after the establishment of the association, the STA may inform the AP about an incipient change of the MAC address, for example, by sending a control frame according to any of the mechanisms described further in paragraphs below.

As shown in FIG. 2, once the change in the MAC address (and the corresponding otaMAC to be used) has been signaled by the STA and acknowledged by the AP, the STA may change the source MAC address (i.e., Address 2) of outgoing frames to the otaMAC address during or after encryption. For example, as shown in FIG. 2, at 210, the STA 210 may have generated frames to be transmitted with a source MAC address set to the nMAC address and a destination address set to the MAC address of the AP 202 (i.e., MACx). As shown at 211, the STA may carry out cryptographic encapsulation of the generated frame. As shown at 212, the change of the nMAC address to the otaMAC address may be performed once the frame has been cyphered and is ready to be transmitted, such that the protection of the frame is performed with the nMAC address; that is, the swapping of nMAC by otaMAC may not impact the cyphering of the frame. In some embodiments, the replacement of the nMAC by otaMAC may be performed at the same time as the cyphering of the frame (e.g., the swap is performed as the generated frame leaves an encryption block or a logical equivalent of such encryption block). In such case, the cyphering may still not be impact by the change. As shown at 213, the STA may transmit encrypted frame to the AP with its source address set to the otaMAC address.

Once received by the AP, at 214, the AP may swap the otaMAC address for the nMAC address before the frame is decrypted, as shown at 215. Therefore, the cryptographic protection of the frame may not be impacted by the change between otaMAC and nMAC. In addition, as shown at 216, the frame may be sent over the wired part of the network (e.g., to a distributed system (DS)) using the nMAC. This may allow for standard L2 forwarding to be performed without any impact on the solutions presented herein.

In the same or similar way, upon reception of a frame from the DS, shown in FIG. 2 at 216, with the destination of the nMAC address of a STA, the AP may encapsulate and cypher the frame with the nMAC address, shown at 217. Prior to transmitting the frame at 219, as shown at 218, the AP may swap the nMAC address by the otaMAC address. The same operation may be performed at the STA upon reception of the frame, shown by elements 220-222 of FIG. 2.

Embodiments described herein may provide mechanisms for advertising and signaling MAC address masquerading capabilities. Solutions for advertisement of MAC address masquerading capabilities may be described in relation to existing procedures defined in IEEE 802.11 standards. A first step may be to enable the advertisement of the MAC address masquerading feature by APs and/or STAs. Some mechanisms for doing so, ordered in level of complexity, may include: (1) the use of one or more bits in an Extended Capabilities field; (2) the use of one or more bits in an RSN element; and (3) the use of one or more bits of a Local MAC Address Policy field.

Solutions involving the extension of an Extended Capabilities field are described herein. IEEE 802.11 standards may provide several mechanisms to advertise its functionalities, and one of them may be the inclusion of one or more bits in an Extended Capabilities field. The one or more bits may indicate the support of MAC address masquerading functionality.

A field, such as the Extended Capabilities field, that indicates support for MAC address masquerading may be included in a management frame or a control frame. A management frame may be a frame that is used by a STA to join or leave a BSS. Examples of management frames may include but are not limited to: association request frames; association response frames; reassociation request frames; reassociation response frames; probe request frames; probe response frames; beacon frames; disassociation frames; deauthentication frames; and action frames. A control frame may be a frame that provides assistance in the delivery of data and/or management frames. Examples of control frames may include, but are not limited to: control wrappers; block acknowledgement (ACK) request frames; block ACK frames; PS-Poll frames; request-to-send (RTS) frames; clear-to-send (CTS) frames; ACK frames; contention-free (CF)-end frames; and CF-end and CF-ACK frames. The Extended Capabilities field may be included to indicate capabilities that augment other capabilities (i.e., those indicated in a Capabilities Information field of the same or another management or control frame).

To signal support for MAC address masquerading procedures, a frame may include one or more bits or bitfields as defined further herein. For example, various new bits of the Extended Capabilities field may be defined, one indicating the support of the functionality, a different one to indicate the support of the functionality through protected control or management frames and a third to indicate the support of MAC address masquerading control information signalling on data packets. A STA that supports any of these capabilities may advertise such support in the transmission of a management or control frame, substantially as described above.

IEEE 802.11 standards may provide support for such MAC address masquerading advertisement through the extension of existing definitions of the Extended Capabilities field. Table 1 illustrates an example of rows that may be added to an existing table defining the Extended Capabilities field.

TABLE 1
Extension to Extended Capabilities field

| Bit | Information | Notes |
|---|---|---|
| 88 (for | MAC address | This bit may be set up based on a MIB variable, for example, |
| example) | masquerading | dot11MACMasqueradingSupport. |
| | | When set to 1 indicates that the STA supports the MAC address |
| | | masquerading capability. When set to 0 indicates the lack of support |
| | | of MAC address masquerading. |
| 89 (for | MAC address | This bit may be set up based on a MIB variable, for example, |
| example) | masquerading | dot11MACMasqueradingSupportProtectedControl. |
| | signalling support | When set to 1 indicates the STA supports the exchange of protected |
| | through protected | control or management frames to signal the binding between the |
| | control/management | otaMAC and the nMAC. |
| | frames | When set to 0 indicates the STA does not support the signalling of |
| | | nMAC to otaMAC bindings through protected control or management |
| | | frames. |
| 90 (for | MAC address | This bit may be set up based on a MIB variable, for example, |
| example) | masquerading | dot11MACMasqueradingSupportSignallingOnData. |
| | signalling support on | When set to 1 indicates the support of signalling MAC address |
| | data packets | masquerading nMAC to otaMAC bindings piggybacked in data |
| | | frames. |
| | | When set to 0, indicates the lack of support of such functionality. |

Solutions for indicating MAC address masquerading capabilities via an RSN element (RSNE) are described herein. Advertisement of a MAC Address Masquerading capability consistent with 802.11 standards may be provided for by a transmission including an RSN Element Such element may be an element consistent with that described in IEEE 802.11-2020 standards. The RSN element may be used to convey information needed to establish an RSNA. The element may be included in a beacon, for example. The RSNE may include a field, referred to herein as an RSN Capabilities field. The field may include subfields providing information on the RSN capabilities such as support for pre-authentication, Peer-Key, and other capabilities.

FIG. 3 illustrates an example of an extension to the RSN capabilities field. Such extension may be consistent with fields illustrated or described in IEEE 802.11-2020 standards. In some examples, a STA may transmit a frame including the RSN capabilities field 300. The RSN capabilities field may include subfields as shown in FIG. 3. Bit 15 of the RSN capabilities field, which may be a reserved bit as described in 802.11 standards, may be populated as a subfield to indicate support for MAC Address Masquerading. For example, a STA that transmits a frame (e.g., a beacon frame) that includes the RSNE and the RSN capabilities field may set the MAC Address Masquerading subfield to 1 to indicate that it supports MAC Address Masquerading. A STA that transmits a frame that includes the RSNE may set the subfield to 0 when it does not support MAC Address Masquerading.

Solutions for obtaining information associated with Local MAC Address Policy capabilities are described herein. A frame element, such as a Local MAC Address Policy ANQP-element may provide a mechanism by which a STA may gather information on a local MAC address policy available for the AP. For instance, a STA that transmits a frame including such element may obtain Local MAC Address Policy information associated with the AP. The information provided by this ANQP-element may allow a STA to obtain a list of Structured Local Address Plan (SLAP) Quadrants to use for the selection of a local MAC address. The local address may be used as, for example, an otaMAC address.

The Local MAC Address Policy field may be structured to as to indicate a MAC Address Masquerading capability of the STA. IEEE 802.11 standards may provide support for such structuring of the Local MAC Address Policy field through the extension of existing definitions of the field. For example, Table 2 illustrates an example of a row that may be added to an existing table defining bits of the Local MAC Address Policy field.

TABLE 1
Example of an extension to Local MAC Address Policy field

| Bitmap Value | Description |
|---|---|
| Bit 5 | MAC Address Masquerading supported |

As shown in Table 2, bit 5, when set to 1, may indicate that the STA supports MAC Address Masquerading. In such case, the STA may select or choose a MAC address from the different ranges as indicated by bits 0 to 4 of the same field. In some embodiments, the STA may avoid choosing MAC addresses beginning with a prefix that is specified in a field, such as the Restricted Address Prefix field. Bit 5, when set to 0, may indicate the MAC Address Masquerading capability is not supported by the STA.

Embodiments for signalling of an otaMAC/nMAC binding are described herein. Such signaling may be carried out via control or management frames that may be used to change the otaMAC of a STA operating in an associated state. These frames may be defined as action frames, and, in some embodiments, the action frames may be transported securely as protected action frames.

FIG. 4 illustrates an example scenario showing an overall exchange and operation of control/management frames. A dialogue as shown in FIG. 4 between a STA 401 and an AP 402 may be carried out as follows. At 410-413, the STA 401 and the AP 402 may exchange frames and acknowledgements with each other using a first otaMAC address “otaMAC1.” At 414, the STA may make a determination to change or modify the its address. At 415, the STA 401 may transmit a MAC Address Masquerading Request to the AP 402, for example, according to one or more embodiments described further herein. The MAC Address Masquerading Request may include, for instance, a second otaMAC address, “otaMAC2.” The STA 401 may then receive a MAC Address Masquerading Response, shown at 416, from the AP 402. Further exchanges of frames, shown by elements 417-420 may be carried out between the STA 401 and the AP 402 using the second otaMAC address.

MAC Address Masquerading Request and the MAC Address Masquerading Response frames may be part of a new category of Action frames. In addition, a new frame to request STAs to change MAC address as signaled by the AP may be defined within this same category of Action frames. An Action frame may have a category field that provides a category value (or code), which may indicate that the frame is a Privacy Action frame. The field may further include information indicating whether the frame is robust (i.e., encrypted), as well as information indicating whether the frame is a group-addressed privacy frame.

The Privacy Action frames described herein may be a new category of Action frames defined consistent with existing 802.11 standards. IEEE 802.11 standards may provide support for such structuring of the Privacy Action frame through the extension of existing definitions of the field. Table 3 illustrates an example of a row that may be added to an existing table defining various Action categories.

TABLE 3
Extensions to Category values

| | | See | | Group addressed |
|---|---|---|---|---|
| Code | Meaning | subclause | Robust | privacy |
| 30 (for | Privacy | 9.6.20 (for | Yes | No |
| example) | | example) | | |

Within the Privacy Action Category, various Action frame formats may be defined. A Privacy Action field may be included in a management frame, for example, immediately after the Category field, and the Privacy Action field may differentiate between the various Action frame formats. Table 4 illustrates an example of Privacy Action field values that may be associated with each frame format.

TABLE 4
Privacy Action field values

| Privacy Action | |
|---|---|
| field value | Description |
| 0 | MAC Address Masquerading Request |
| 1 | MAC Address Masquerading Response |
| 2 | MAC Address Masquerading Switch Announcement |
| 3-255 | Reserved |

The following paragraphs discuss the format of each of the Privacy Action frames defined above. The MAC Address Masquerading Request may be sent by a STA to update the otaMAC address used in communication with the peer STA or AP.

FIG. 5 shows an example of a format of the MAC Address Masquerading Request frame. The Category field may indicate that the frame is a Privacy Action frame, substantially as described above. The Privacy Action field values may be as defined above in Table 4. The Number of Masquerading Options field may indicate a number of Masquerading Options fields included in the frame. The value of this field may be at least 1. The Masquerading Options field included in the MAC Address Masquerading Request frame is described further in subsequent paragraphs with respect to FIG. 6.

FIG. 6 portrays an example of a Masquerading Options field as may be included in a MAC Address Masquerading Request Frame. The Masquerading Options field may include one or more of: a Control subfield (described further in subsequent paragraphs with respect to FIG. 7), an otaMAC subfield, a TBTTs to Change subfield, a Frames Before Change subfield, and an ID subfield. The otaMAC field may contain a 48-bit MAC address, which the STA may advertise to the peer STA and the next otaMAC to be used in the transmitted frames. The TBTTs To Change may indicate in TBTT periods the elapsed time between the next TBTT period (TBTTs to Change set to 0) and the time when the otaMAC signaled in the Masquerading Options will be used as the MAC address of the STA for transmitted frames. The Frames Before Change field may indicate the number of frames (in units of 10 frames) until the change of MAC address to the one specified in the otaMAC. The ID field may indicate the possibility of including a STA ID provided by some other mechanism, out of the scope of this document. Finally, the Vendor Specific field may be defined for vendor specific signaling.

FIG. 7 portrays an example of a Control subfield as may be included in a Masquerading Options field of the MAC address Masquerading Request frame. The TBTTs to Change Present subfield, when set to 1, may indicate the presence of the TBTTs to Change subfield in the Masquerading Options field. When set to 0, it may indicate the absence of the TBTTs to Change subfield in the Masquerading Options field. The Frames Before Change Present subfield, when set to 1, may indicate the presence of the Frames Before Change subfield in the Masquerading Options field. When set to 0, the Frames Before Change Present subfield may indicate the lack of the Frames Before Change subfield in the Masquerading Options field. The Length ID subfield may indicate the length of the ID subfield in the Masquerading Options field. A value of 0 may indicate that the ID subfield is not included in the Masquerading Options subfield.

Formats of the MAC Address Masquerading Response frame are described herein. The MAC Address Masquerading Response may act as an acknowledgement of the MAC Address Masquerading Request frame, and may be sent by a STA or an AP after a MAC Address Masquerading Request frame is received indicating the status of the request and a lifetime indicating the validity of the otaMAC to nMAC binding.

FIG. 8 illustrates an example format of the MAC Address Masquerading Response frame. The Category field may indicate that the frame is a Privacy Action frame, substantially as described in paragraphs above. The Privacy Action field values may indicate that the frame is a MAC Address Masquerading Response frame as defined in Table 4. The Status field may indicate the result of the nMAC to otaMAC binding operation, as provided in Table 5 below. For instance, the Status field may indicate whether the binding was successful, whether the binding was rejected, and if rejected, the Status field may further indicate a reason for the rejection.

TABLE 5
Status codes for the result of nMAC to otaMAC binding

| Value | Description |
|---|---|
| 0 | Reserved |
| 1 | Binding Succeeded |
| 2 | Binding Rejected - not supported |
| 3 | Binding Rejected due to otaMAC not in a valid range |
| 4 | Binding Rejected - administrative prohibited |
| 5-255 | Reserved |

The TTL (Time to Live) field may indicate the lifetime of the binding. The originator of the MAC Address Masquerading Request may update the binding or change the otaMAC within the lifetime of the binding. Failure to do so may trigger the removal of the RSNA and all states of the association, and may require a new association. Finally, the Vendor Specific field may be defined for vendor-specific signalling.

Some or all the above defined frames may need to be transmitted in a protected way such that the otaMAC and nMAC binding is not disclosed. Therefore, it may be advantageous that these two frames be designated as protected frames. Protected frames may be included in a list of Protected Dual of Public Action frames.

The MAC Address Masquerading Switch announcement is described in further detail in the following paragraphs. A MAC Address Masquerading Switch announcement frame may be used to request all STAs or a set of STAs to change their MAC address within a period of time. A STA that receives the request may select a next MAC address, for example, from a list signaled in a previous message exchange.

FIG. 9 illustrates an example of a definition of the MAC Address Masquerading Switch Announcement frame 900. In embodiments not depicted, the frame may be defined using Elements instead of being directly declared as a frame. The Category field may indicate that the frame is a Privacy Action frame, substantially as described in paragraphs above. The Privacy Action field value may indicate that the frame is a MAC Address Masquerading Switch Announcement frame, for example, consistent with Table 4 above. The Max TBTTs To Change field may indicate the maximum number of TBTTs elapsed from the next TBTT (Max TBTTs To Change set to 0) to perform the change of MAC address to the otaMAC already signaled to the AP using previous messages. The AIDs To Change subfield may include a list of STAs, identified by their AIDs, that are requested to change. The AIDs To Change field may have the form of a synthetic receiver address (SYNRA) consistent with 802.11 standards.

Upon reception of the MAC Address Masquerading Switch Announcement frame, STAs identified by the field AIDS To Change (or all STAs receiving this frame if this field is not included) may change their MAC address to the next otaMAC as signaled, before the period specified by the Max TBTTs To Change field has elapsed.

Embodiments providing for signaling of the otaMAC/nMAC binding are described herein. The otaMAC/nMAC binding may be signaled, for example, in data packets and/or acknowledgments. For instance, in addition to signaling of the otaMAC/nMAC binding via control and management frames as described substantially in paragraphs above, the binding may be piggybacked in a data frame. Such proposed mechanism may make use of the CCMP header; therefore, it may only be available to STAs using this kind of protection. By contrast in solutions involving the control/management frames described in paragraphs above may be used regardless of the protection mechanism or mechanisms used by the involved STAs. In addition, in some cases, the COMP header may only be transferred between STAs in the case of frames transmitted with a Protocol Version 0 (PV0) format, which may be the default MAC frame format for transmissions consistent with 802.11 standards. For instance, in such cases, the COMP header may not be transferred between STAs via Protocol Version 1 (PV1) frames, which may be optionally supported by 802.11 standards and have less overhead than PV0 frames.

Solutions involving CCMP header extensions and otaMAC signalling for PV0 frames are described herein.

FIG. 10 portrays an example of CCMP header extension and piggybacking of the otaMAC information. As illustrated in FIG. 10, MAC Address Masquerading information may be included within a PV0 data frame. A STA may transmit the PV0 frame including the MAC Address Masquerading information to, for example, an AP or another STA. One or more bits in the CCMP Header may be used to indicate the addition of the otaMAC field in an encrypted portion of the payload. In the case the Privacy Bit is set to 1, the encrypted payload may contain an additional 6 octets that include the otaMAC field. In case the Privacy Bit is set to 0, the otaMAC field may not be added. The otaMAC may be transmitted in the encrypted part of the PDU, and it such cases, it may be protected.

FIG. 11 illustrates an example of an extension to the ACK frame format. The signaling of the otaMAC address in a protected PDU may require an acknowledgement from a peer STA or AP to start using the otaMAC address in transmission. Such embodiments may require extensions to the ACK frame providing information on the status of the MAC Address Masquerading operation. The proposed extension to the ACK frame may be consistent with the format of a MAC Address Masquerading Response frame as presented in FIG. 9.

FIG. 12 illustrates an example of an otaMAC Ack field as may be included in a ACK frame. As shown in FIG. 12, the otaMAC Ack field may include one or more of a Status subfield and/or a TTL subfield. Possible values of the Status subfield may be as detailed in Table 5. In addition to the above modification of the ACK frame, a standard ACK frame without modification may also be used to acknowledge the reception of the frame and the processing of the otaMAC, although it may provide less information to the STA. In any case, a standard ACK frame may, in some instances, not be sent in response to a data frame including an otaMAC if any of the STAs involved in the communication do not support MAC Address Masquerading.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A station (STA) comprising:
a transmitter configured to transmit, to an access point (AP) that the STA is associated with, a first frame including information indicating that the STA is to transmit a frame to the AP using an over-the-air medium access control (otaMAC) address; and
a processor configured to:
generate a second frame including a network MAC (nMAC) address that identifies the STA,
encrypt the generated second frame, and
replace the nMAC address with the otaMAC address either during the encryption or after the encryption;
wherein the transmitter is further configured to transmit the encrypted second frame, including the otaMAC, to the AP.

2. The STA of claim 1 further comprising a receiver configured to receive, from the AP, a third frame including the otaMAC address, wherein the processor is further configured to replace the otaMAC address with the nMAC address and to decrypt the third frame.

3. The STA of claim 1, wherein, prior to the transmission of the first frame including the otaMAC address, a robust security network association (RSNA) is established between the STA and the AP.

4. The STA of claim 1, wherein the transmitter is configured to transmit a privacy action frame to the AP including information indicating a request, by the STA, to update the otaMAC address.

5. The STA of claim 4, wherein the privacy action frame further includes information indicating the updated otaMAC address to be transmitted in a subsequent frame.

6. The STA of claim 5, wherein the privacy action frame further includes information indicating one or more of a number of time periods before the updated otaMAC address will be used in a subsequent frame or number of frames before the updated otaMAC address will be used in a subsequent frame.

7. The STA of claim 4 further comprising a receiver configured to receive a response to the request to update the otaMAC address, the response including information indicating that the request to update the otaMAC address is accepted and information indicating a duration during which the updated otaMAC address is valid.

8. A method for use in privacy enhancement performed by a station (STA), the method comprising:
transmitting, to an access point (AP) that the STA is associated with, a first frame including information indicating that the STA is to transmit a frame to the AP using an over-the-air medium access control (otaMAC) address;
generating a second frame including a network MAC (nMAC) address that identifies the STA;
encrypting the generated second frame;
replacing the nMAC address with the otaMAC address either during the encryption or after the encryption; and
transmitting the encrypted second frame, including the otaMAC, to the AP.

9. The method of claim 8 further comprising receiving, from the AP, a third frame including the otaMAC address, replacing the otaMAC address with the nMAC address, and decrypt the third frame.

10. The method of claim 8, wherein, prior to the transmission of the first frame including the otaMAC address, a robust security network association (RSNA) is established between the STA and the AP.

11. The method of claim 8 further comprising transmitting a privacy action frame to the AP including information indicating a request, by the STA, to update the otaMAC address.

12. The method of claim 11, wherein the privacy action frame further includes information indicating the updated otaMAC address to be transmitted in a subsequent frame.

13. The method of claim 12, wherein the privacy action frame further includes information indicating one or more of a number of time periods before the updated otaMAC address will be used in a subsequent frame or number of frames before the updated otaMAC address will be used in a subsequent frame.

14. The method of claim 11 further comprising receiving a response to the request to update the otaMAC address, the response including information indicating that the request to update the otaMAC address is accepted and information indicating a duration during which the updated otaMAC address is valid.

15. An access point (AP) comprising:
a receiver configured to receive, from a station (STA) that the AP is associated with, a first frame including information indicating that the STA is to transmit a frame to the AP using an over-the-air medium access control (otaMAC) address, wherein the receiver is further configured to receive a second frame from the STA including the otaMAC address; and
a processor configured to replace the otaMAC address included in the second frame with a network MAC (nMAC) address that identifies the STA and to decrypt the second frame for forwarding via a distribution system (DS), wherein the replacement of the otaMAC address included in the second frame with the nMAC address is performed either during the decryption or after the decryption.

16. The AP of claim 15, the processor configured to generate a third frame including the nMAC address and to replace the nMAC address with the otaMAC address; and
the transmitter further configured to transmit the third frame including the otaMAC address to the STA.

17. The AP of claim 15, wherein, prior to the reception of the first frame including the otaMAC address, a robust security network association (RSNA) is established between the AP and the STA.

18. The AP of claim 15, wherein the receiver is further configured to receive a privacy action frame from the STA including information indicating a request to update the otaMAC address.

19. The AP of claim 18, wherein the privacy action frame further includes information indicating the updated otaMAC address to be received in a subsequent frame.

20. The AP of claim 19, wherein the privacy action frame further includes information indicating one or more of a number of time periods before the updated otaMAC address will be used in a subsequent frame or number of frames before the updated otaMAC address will be used in a subsequent frame.

21. (canceled)

22. (canceled)

23. (canceled)

24. (canceled)
